(19) United States
(12) Patent Application Publication
(10) Pub. No.: US 2026/0310514 A1
(43) Pub. Date: Oct. 8, 2026

(54) GENERATION OF INTENT EMBEDDINGS USED FOR INFORMATION RECOMMENDATIONS

(71) Applicant: Dell Products L.P., Round Rock, TX (US)

(72) Inventors: ZIJIA WANG, London (GB); XIAOCHEN CHEN, Shanghai (CN); RUI CHEN, Shanghai (CN); NING LI, Shanghai (CN)

(21) Appl. No.: 19/098,650

(22) Filed: Apr. 2, 2025

(51) Int. Cl. G06F 9/50; G06N 20/00

(52) U.S. Cl. CPC G06F 9/5033; G06N 20/00

(57) ABSTRACT

Methods and systems for managing data sources of a distributed system are disclosed. The data sources may be managed by generating intent embeddings used for information recommendations. The intent embeddings may include a combination of embeddings based on at least one discrete action of a entity and/or at least one behavior of the entity. The intent embeddings may further include any embedding of data (e.g., (i) data headers, (ii) data statistics, and/or (iii) any other component of the data) of the data sources. The entity may include (i) a user, (ii) an administrator, etc. of the distributed system. The intent embeddings may be used to obtain an information recommendation for a request by the entity. The information recommendation may be used to facilitate desired computer implemented services.

### FIELD

Embodiments disclosed herein relate generally to managing data sources of a distributed system. More particularly, embodiments disclosed herein relate to generating intent embeddings used for information recommendations.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2C show data flow diagrams illustrating operation of the distributed system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing data sources of a distributed system. The data sources may be managed by generating intent embeddings used for information recommendations.

The intent embeddings may be generated by (i) performing a cluster analysis of discrete actions of a entity to generate a first embedding based on a behavior of the entity and/or (ii) generating a combination of at least a first embedding and/or at least a second embedding based on a discrete action of the entity. Further, any first portion of a third embedding based on data headers of data and/or any second portion of fourth embedding based on the data statistics of the data may be included in the intent embeddings.

After a request for information has been received from an entity of the distributed system, the request may be processed using the intent embeddings and/or embeddings for the data sources. The request may be processed by identifying, using at least the intent embeddings and/or the embeddings for the data sources, to obtain the information recommendations (i.e., data that is relevant to the request). Using the information recommendations, desired computer implemented services may be provisioned.

In an embodiment, a method for managing data sources of a distributed system is disclosed. The method may include: (i) obtaining a request for information from an entity, (ii) identifying an intent embedding of the entity with respect to the request, (iii) processing the request using embeddings for the data sources and the intent embedding of the entity to obtain an information recommendation, and (iv) using the information recommendation to facilitate provisioning of desired computer implemented services

The request for the information may lack details about the information.

The embeddings for the data sources may correspond to at least data headers, data statistics, and a set of discrete actions performed by entities in the past, the set of the discrete actions having been performed on the distributed system before the request for the information is obtained.

The information recommendation may include an identification of relevant data of the data sources, based on at least the set of the discrete actions performed by the entity, for use in the provisioning of the desired computer implemented services.

A discrete action of the discrete actions may include a single task performed by the entity on the distributed system using data of the data sources that does not indicate a class of behavior based on a sequence of single tasks.

Identifying the indent may include (i) obtaining the set of the discrete actions performed by the entity in the past with respect to the data sources, and (ii) obtaining the intent embedding for the set of actions based on an embedding schema used, at least in part, to obtain the embeddings for the data sources.

The intent embedding may correspond to a behavior of a set of behaviors.

The behavior of the set of the behaviors may include at least one selected from a list consisting of: (i) data exploration, (ii) data preparation, (iii) insight generation, (iv) operational management, and/or (v) incident response generation.

The intent embedding may be based on at least one discrete action of the entity and on the behavior of the entity.

The intent embedding may be generated using unsupervised learning using at least the at least one discrete action of the entity.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

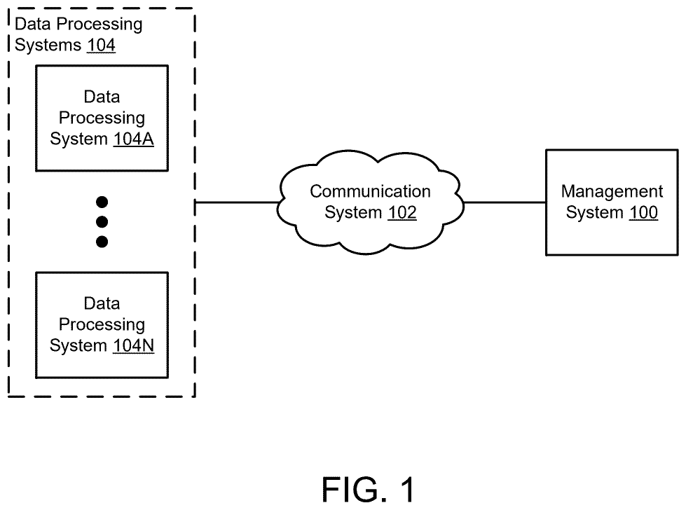

Turning to FIG. 1, a distributed system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a request for information may be performed by an entity of the distributed system. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc. The request may be performed by (i) transmitting the request to the distributed system, (ii) retrieving, based on any parameter of the request and/or by the distributed system, information from software, databases, repositories, etc. of the distributed system, and/or (iii) transmitting, by the distributed system, the information to the entity.

However, the information, which has been retrieved by the distributed system, may not include (i) data, (ii) metadata, (iii) statistics, (iv) annotations, etc. that is relevant to at least one requirement and/or activity of the entity on the distributed system. As a result, provisioning, using the information and/or by the entity, of computer implemented services may be impacted.

In general, embodiments disclosed here relate to systems and methods for managing data sources used by a distributed system. The data sources may be managed by (i) obtaining a request for information from an entity, (ii) identifying an intent embedding of the entity with respect to the request, (iii) processing the request using embeddings for the data sources and/or the intent embedding of the entity to obtain an information recommendation, and/or (iv) using the information recommendation to facilitate provisioning of desired computer implemented services.

The request may be obtained by receiving, by the distributed system and/or from the entity, for the information. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc.

An intent embedding may be identified by generating the intent embedding. An embedding of the intent embedding may be represented, for example, as an n-dimensional vector and/or any other numerical representation. The intent embedding may be generated by combining using a combination method (e.g., concatenation, weighted sum, element-wise multiplication, averaging, principal component analysis, and/or any other combination method) at least one first embedding and/or at least one second embedding.

The at least one first embedding may correspond to at least one discrete action of the entity. The at least one discrete action may include a first action presently performed by the entity and/or a second action historically performed by the entity. The at least one second embedding may represent a behavior of the entity. The behavior may include (i) data exploration, (ii) data preparation, (iii) insight generation, (iv) operational management, (v) incident response generation, etc.

The at least one second embedding may be generated using a trained machine learning model. The trained machine learning model may include (i) a K-means model, (ii) Density-Based Spatial Clustering of Applications with Noise (DB-SCAN), (iii) Gaussian Mixture Models, (iv) OPTICS (Ordering Points to Identify the Clustering Structure), BIRCH (Balanced Iterative Reducing and Clustering using Hierarchies), etc.

The at least one second embedding may be generated by ingesting, by the trained machine learning model, further discrete actions based on and/or following the first action. Using the further discrete actions by the trained machine learning model, a behavior of the entity may be identified.

The request may be processed by using the intent embedding, a set of historical actions of the entity, and/or the embeddings for the data sources to filter, prioritize, and/or retrieve the information recommendation of the request. The information recommendation may include an identification of relevant data for use in the provisioning of the desired computer implemented services. The information recommendation may be formatted according to at least one requirement of the request. The information recommendation may then be transmitted from the distributed system to the entity.

The information recommendation may be used to facilitate provisioning of desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

To provide the above noted functionality, the system may include management system 100 and data processing systems 104. Each of these components is discussed below.

Data processing systems 104 may include any number of data processing systems (e.g., 104A-104N). The any number of data processing systems may host an entity. The entity may include (i) a user, (ii) an administrator, and/or (iii) any other stakeholder of the distributed system. The entity may perform a request for information. The request may be received by the any number of data processing systems (e.g., 104A-104N).

To process the request, the any number of data processing systems (e.g., 104A-104N) may ingest at least the request, at least one intent embedding, and/or historical actions of the entity. The any number of data processing systems (e.g., 104A-104N) may generate, using at least the request, the at least one intent embedding, and/or the historical actions, the information recommendation. The information recommendation may be transmitted, by the any number of the data processing systems (e.g., 10A-104N), to the entity.

The any number of data processing systems (e.g., 104A-104N) may also include at least one entity device of the entity. By the at least one entity device, the entity may process the request and/or receive the information recommendation.

To generate the intent embeddings, management system 100 may assign the any number of data processing systems (e.g., 104A-104N) to (i) segment data into at least (a) data headers, (b) data statistics, and/or (c) entity actions, (ii) generate embeddings using the at least (a) the data headers, (b) the data statistics, (c) the entity actions, and/or (iii) perform a behavior derivation analysis using at least the entity actions and/or a trained machine learning model. The data may be stored in a repository of the any number of data processing systems (e.g., 104A-104N).

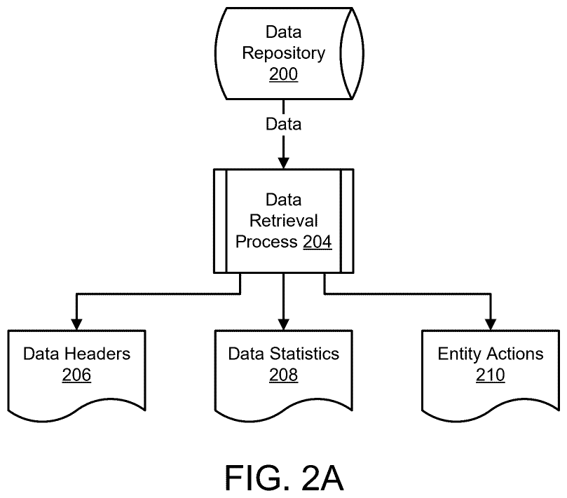

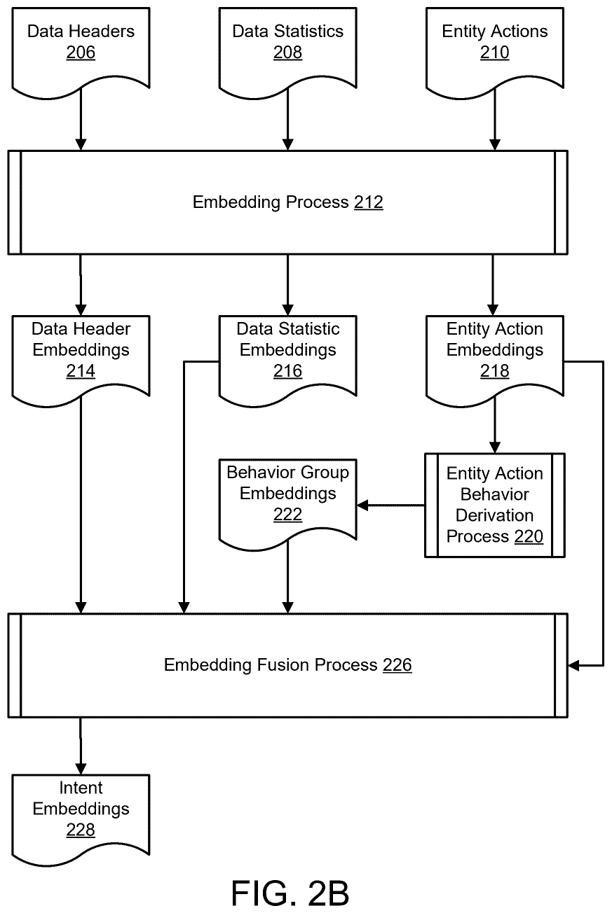

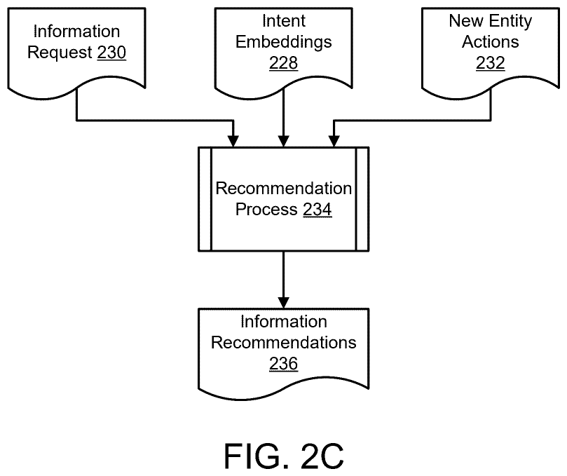

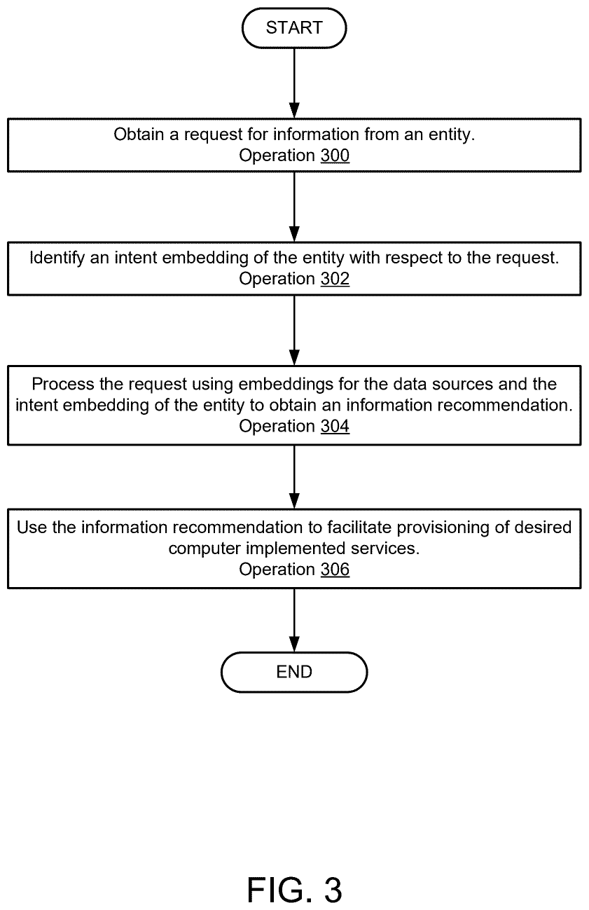

While providing their functionality, any of management system 100 and data processing systems 104 may perform all, or a portion, of the flows and methods shown in FIGS. 2A-3.

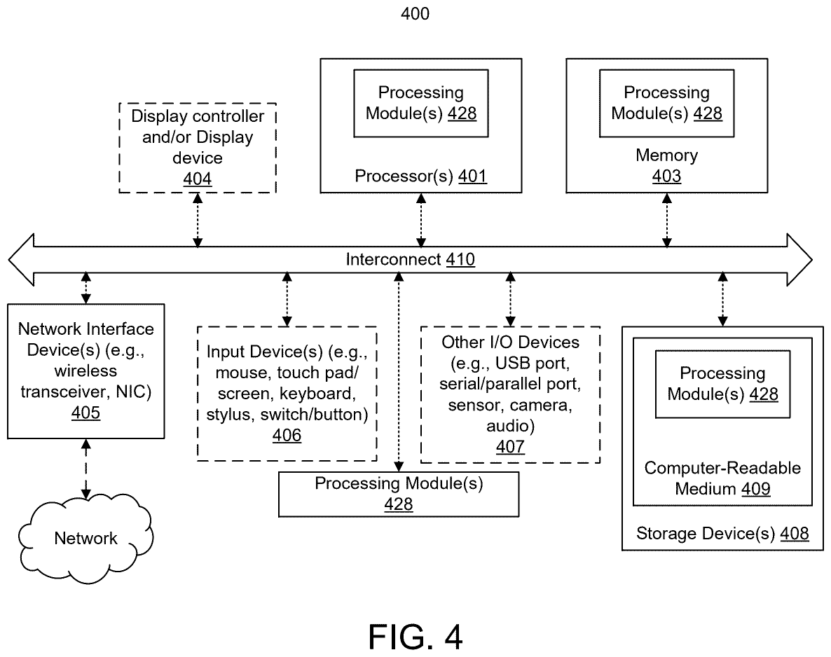

Any of (and/or components thereof) management system 100 and data processing system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 206, 208, etc.) is used to represent data structures, a second set of shapes (e.g., 212, 220, etc.) is used to represent processes performed using and/or that generate data, and a third set of shapes (e.g., 200, etc.) is used to represent large scale data structures such as databases.

Turning to FIG. 2A, a first data flow diagram in accordance with an embodiment is shown. The first data flow diagram may illustrate data used in and data processing performed in obtaining data headers, data statistics and/or entity actions of data of data sources.

To obtain the data headers (e.g., 206), the data statistics (e.g., 208) and/or the entity actions (e.g., 210), data retrieval process 204 may be performed. During the data retrieval process (e.g., 204), the data may be obtained from a data repository (e.g., 200) and/or segmented into the data headers (e.g., 206), the data statistics (e.g., 208) and/or the entity actions (e.g., 210).

An entity may include (i) a user, (ii) an administrator, and/or (iii) any other stakeholder of the distributed system. The data repository (e.g., 200) may include (i) data warehouses (e.g., aggregates and/or organizes data from at least one source), (ii) data lakes (e.g., stores the data in native formats), (iii) content management systems (e.g., store digital content including documents, multimedia files, logs, and/or any other digital content), (iv) file systems (e.g., organize and/or manage files and/or directories), etc.

During data retrieval process 204, the data may be obtained using (i) a keyword search, (ii) a semantic search, (iii) a faceted search (e.g., a search using at least one predefined category of the data), (iv) a temporal search (e.g., a search of the data based on timestamps of the data), (v) a graph search (e.g., a search of the data using relationships between data sources on a graph data structure), etc.

Once the data has been obtained, the data may be segmented by (i) performing a first search of the data for first information that defines a structure and/or content of the data, (ii) performing a second search of the data for second information that provides numerical information and/or numerical summaries of the data, and/or (iii) performing a third search of the data for third information that includes the entity actions (e.g., 210) that were initiated and/or performed to generate the data.

The data headers (e.g., 206) may include (i) identifiers (e.g., (a) numeric strings, (b) alphanumeric strings and/or (c) any other string identification), (ii) descriptive attributes (e.g., (a) a name, (b) a category, (c) a brand, and/or (d) any other descriptive attribute), (iii) metadata (e.g., (a) source location in the data repository (e.g., 200), (b) data format, (c) last date of modification, and/or (d) any other metadata), etc.

The data statistics (e.g., 208) may include (a) a central tendency (e.g., (a) mean, (b) median, (c) mode, and/or (d) any other first measure that represents a center of the data), (b) dispersion (e.g., (a) range, (b) variance, (c) standard deviation, and/or (d) any other second measure that describes a spread of the data), (iii) patterns over time (e.g., (a) access count, (b) modification count, (c) permitted entity count, (d) identification count, and/or (e) any other pattern over the time), etc.

The entity actions (e.g., 210) may include (i) search actions for the data, (ii) authentication actions (e.g., access count and/or access times for entities), (iii) file modifications (e.g., (a) additions, (b) deletions, (c) migrations, and/or (d) any other file modifications), (iv) engagement actions (e.g., (a) likes, (b) comments, (c) favorites, (d) comments, and/or any other engagement actions), (v) performance of any software that ingests the data, etc.

Thus, via the first data flow diagram illustrated in FIG. 2A, a system in accordance with an embodiment may obtain the data headers (e.g., 206), the data statistics (e.g., 208) and/or the entity actions (e.g., 210) of the data of the data sources. Consequently, a distributed system may be more likely to be able to provide desired computer implemented services by segmenting the data into categories of and/or related to the data.

Turning to FIG. 2B, a second data flow diagram in accordance with an embodiment is shown. The second data flow diagram may illustrate data used in and data processing performed in generating intent embeddings related to entities that utilize data sources.

To generate the intent embeddings (e.g., 228), an embedding process (e.g., 212) may be performed. During the embedding process (e.g., 212), the data headers (e.g., 206), the data statistics (e.g., 208) and/or the entity actions (e.g., 210) may be ingested by the embedding process (e.g., 212) to generate data headers embeddings (e.g., 214), data statistics embeddings (e.g., 216) and/or the entity actions embeddings (e.g., 218).

The data headers (e.g., 206), the data statistics (e.g., 208) and/or the entity actions (e.g., 210) are described in the description of FIG. 2A.

To generate data headers embeddings (e.g., 214), the data headers (e.g., 206) may be ingested in a first word embedding model (e.g., Word2Vec, Global Vectors (i.e., GloVe), Bidirectional encoder representations from transformers (i.e., BERT), and/or any other first word embedding model) to convert any text of the data headers (e.g., 206) into the data header embeddings (e.g., 214). The data header embeddings (e.g., 214) may include first n-dimensional vectors and/or any other first numerical representation of the data headers (e.g., 206).

To generate data statistic embeddings (e.g., 216), the data statistics (e.g., 208) may be (i) normalized to have magnitudes in a range (e.g., (a) 0 to 1, (b) 0 to 100, and/or (c) any other range) to generate normalized data statistics and/or (ii) the normalized data statistics may be combined into at least one second embedding of the data statistic embeddings (e.g., 216). A first combination method used to generate the data statistic embeddings (e.g., 216) may include (i) a concatenation, (ii) a weighted sum, (iii) an element-wise multiplication, (iv) averaging, (v) a principal component analysis, and/or (vi) any other combination method. The data statistic embeddings (e.g., 216) may include second n-dimensional vectors and/or any other second numerical representation of the data statistics (e.g., 208).

To generate entity action embeddings (e.g., 218), (i) the entity actions (e.g., 210) may be segmented into discrete actions, (ii) the discrete actions may be converted into discrete action embeddings, and/or (iii) the discrete action embeddings may be transformed into the entity action embeddings (e.g., 218).

The entity actions (e.g., 210) may be segmented by identifying the discrete actions of the entity actions (e.g., 210). The discrete actions may include (i) a first selection by the entity a first software, (ii) a second selection at least one setting of the software, (iii) a third selection of a first portion of the data for ingestion by the first software, (iv) a fourth selection a first process of the software that uses the first portion of the data, (v) a first processing of the first process, etc. The discrete actions may be ingested by a second word embedding model (e.g., Word2Vec, Global Vectors (i.e., GloVe), Bidirectional encoder representations from transformers (i.e., BERT), and/or any other second word embedding model) to convert the discrete actions into the discrete action embeddings.

The discrete action embeddings may be transformed by combining the discrete action embeddings. A second combination method used to generate the entity action embeddings (e.g., 218) may include (i) the concatenation, (ii) the weighted sum, (iii) the element-wise multiplication, (iv) the averaging, (v) the principal component analysis, and/or (vi) the any other combination method.

The entity action embeddings (e.g., 218) may be ingested during an entity action behavior derivation process (e.g., 220) to generate behavior group embeddings (e.g., 220). During the entity action behavior derivation process (e.g., 220), the entity action embeddings (e.g., 218) may be ingested by a trained machine learning model to perform a clustering analysis. During the clustering analysis, categories of behaviors of the entities may be identified based on the entity action embeddings (e.g., 218). The behavior group embeddings (e.g., 222) may include (i) the categories of the behaviors of the entity's and/or (ii) cluster centroids of the categories that are computed by the first trained machine learning model.

The trained machine learning model may include (i) a K-means model, (ii) Density-Based Spatial Clustering of Applications with Noise (DB-SCAN), (iii) Gaussian Mixture Models, (iv) OPTICS (Ordering Points to Identify the Clustering Structure), BIRCH (Balanced Iterative Reducing and Clustering using Hierarchies), etc. Further, the trained machine learning model may be adapted to perform clustering analyses to identify the categories of the behaviors of the entities. The categories of the behaviors of the entities may include (i) data exploration, (ii) data preparation, (iii) insight generation, (iv) operational management, and/or (v) incident response generation.

The data statistic embeddings (e.g., 216), the data statistic embeddings (e.g., 216), and/or the behavior group embeddings (e.g., 222) may be ingested in an embedding fusion process (e.g., 226). During the embedding fusion process (e.g., 226), intent embeddings (e.g., 228) may be generated. The intent embeddings (e.g., 228) may be generated by combining (i) at least one discrete action embedding of the discrete action embeddings and/or at least one behavior group embedding of the behavior group embeddings (e.g., 222) to generate a third combination.

Values of weights of the third combination may be changed based on, for example, (i) context sensitivity, (ii) entity variation, (iii) temporal relevance, and/or (iv) behavior significance of either the at least one discrete action embedding and/or the at least one behavior group embedding. The third combination method used to generate the intent embeddings (e.g., 228) may include (i) the concatenation, (ii) the weighted sum, (iii) the element-wise multiplication, (iv) the averaging, (v) the principal component analysis, and/or (vi) the any other combination method.

The intent embeddings (e.g., 228) may include the third combination of the at least one discrete action embedding and/or the at least one behavior group embedding. At least one intent embedding of the intent embeddings (e.g., 228) may be used, by a distributed system, to provide information recommendations of data sources based on new actions of the entity. The description of FIG. 2C further describes on how the information recommendations are generated.

Further, a third portion of the data headers embeddings (e.g., 214) and/or a fourth portion of the data statistic embeddings (e.g., 216) may be included in the intent embeddings (e.g., 228). The third portion and/or the fourth portion may be included to provide semantic meaning and/or numerical context with the intent embeddings (e.g., 228). The semantic meaning and/or the numerical context with the intent embeddings (e.g., 228) may further enhance an accuracy and/or personalization of the information recommendations of the data sources based on the new actions of the entity.

Thus, via the first data flow diagram illustrated in FIG. 2B, a system in accordance with an embodiment may generate the intent embeddings (e.g., 228) related to entity that utilize the data sources. Consequently, a distributed system may be more likely to be able to provide desired computer implemented services by making available the information recommendations of the data sources that are relevant to the new actions of the entity.

Turning to FIG. 2C, a third data flow diagram in accordance with an embodiment is shown. The third data flow diagram may illustrate data used in and data processing performed in generating an information recommendation.

To generate the information recommendation (e.g., 236), a recommendation process (e.g., 234) may be performed. During the recommendation process (e.g., 234), an information request (e.g., 230), intent embeddings (e.g., 228) and/or new entity actions (e.g., 232) may be ingested.

The intent embeddings (e.g., 228) may be described in the description of FIG. 2B. The information request (e.g., 230) may include (a) a request, such as, for example, “A request for latest advancements in artificial intelligence,”, (b) a request context, such as, for example, “the entity making the request is a data scientist,” (c) an intent, such as, for example, “I seek to utilize a new technology for a new project,” (d) a constraint, such as, for example, “the advancements were published within the last year,” etc.

The new entity actions (e.g., 232) may include at least one recent action performed by the entity concerning the information request (e.g., 230). The one recent action may include (a) at least one mouse click on any software, (b) any searches performed concerning the information request (e.g., 230), (c) time spent on the any software by the entity, (d) at least one input of the entity into the distributed system regarding the information request (e.g., 230), etc.

During the recommendation process (e.g., 234), the information request (e.g., 230) and/or the new entity actions (e.g., 232) may be ingested by the distributed system to obtain elements such as (a) words, (b) phrases, (c) software, (d) websites, (e) discrete actions, and/or (f) any other element of the information request (e.g., 230) and/or the new entity actions (e.g., 232). Then, performance of (a) keyword searches, (b) semantic searches, (c) similarity searches, and/or (d) any other search technique with the elements may be facilitated by the distribution system to identify a first portion of data of data sources of the distributed system. The element embeddings of the elements may be generated using a third word embedding model. Similarity computations may be performed using the element embeddings and/or the intent embeddings (e.g., 228) to generate similarity scores. Finally, any sub-portion of the first portion of the data may be rank ordered based on at least the similarity scores to generate the information recommendations (e.g., 236).

The third word embedding model may be similar to the second word embedding model described in the description of FIG. 2B. The similarity computations may include computations of (i) a cosine similarity, (ii) a Euclidean distance, (iii) a Jaccard similarity, (iv) a Manhattan distance, (v) a Minkowski Distance, and/or (vi) any other distance. Similarity scores of the similarity computations may include different ranges based on the similarity computations. In a first example, a cosine similarity score includes a single integer bounded and/or including 0.0 and/or 1.0. The cosine similarity score further includes a measure of an angle between two vectors of the numerical representations. A first score of 1.0 includes perfect similarity between the two vectors and/or a second score of 0.0 includes no similarity between the two vectors. In a second example, a Euclidean distance also includes the single integer bounded and/or including 0.0 and/or infinity. The Euclidean distance further includes a straight line distance between two points in multi-dimensional space. The two points may be obtained from the two vectors of the numerical representations. A low value for the Euclidean distance may include high similarity between the two vectors and/or a high value for the Euclidean distance may include low similarity between the two vectors.

The rank-ordering may prioritize values of the similarity scores that correspond to higher similarity between any sub-portion of the portion of the data and/or the intent embeddings (e.g., 228). Thus, the any sub-portion of the portion of the data that is most similar to the intent embeddings (e.g., 228) may be ranked highest.

The information recommendations (e.g., 236) may include the rank-ordering of the any sub-portion of the portion of the data that includes at least some similarity and/or some dissimilarity to the intent embeddings (e.g., 228). The information recommendations (e.g., 236) may include (i) a title for the sub-portion, (ii) a summary of the sub-portion, (iii) a link and/or source to obtain the sub-portion, (iv) context for relevancy of the sub-portion to the information request (e.g., 230), (v) related data of the sub-portion, (vi) entity ratings of quality of the sub-portion, (viii) additional context and/or metadata of the sub-portion, etc.

Thus, via the third data flow diagram illustrated in FIG. 2C, a system in accordance with an embodiment may generate an information recommendation (e.g., 236). Consequently, a distributed system may be more likely to be able to provide desired computer implemented services by facilitating obtainment of information (e.g., the sub-portion of the portion of the data) using at least the intent embeddings (e.g., 228)

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to managing data sources of a distributed system. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the data sources of the distributed system in accordance with an embodiment is shown. The method may be performed, for example, by any of the components of the system of FIG. 1, and/or other components not shown therein.

At operation 300, a request may be obtained for information from an entity. The request may be obtained by (i) transmitting the request to the distributed system, (ii) retrieving, based on any parameter of the request and by the distributed system, the information from software, databases, repositories, etc. of the distributed system, and/or (iii) transmitting, by the distributed system, the information to the entity. The information may include (i) performance data of the distributed system, (ii) traffic data of the distributed system, (iii) inventory data of items tracked by software of the distributed system, (iv) sales statistics in a database of the distributed system, etc.

At operation 302, an intent embedding of the entity with respect to the request may be identified. The intent embedding may be identified by generating the intent embedding. The intent embedding may be generated by combining using a combination method (e.g., a concatenation, a weighted sum, an element-wise multiplication, a averaging, a principal component analysis, and/or any other combination method) at least one first embedding and/or at least one second embedding.

The at least one first embedding may correspond to at least one discrete action of the entity. The at least one discrete action may include a first action presently performed by the entity and/or a second action historically performed by the entity. The at least one second embedding may represent a behavior of the entity. The behavior may include (i) data exploration, (ii) data preparation, (iii) insight generation, (iv) operational management, and/or (v) incident response generation.

The at least one second embedding may be generated using a trained machine learning model. The trained machine learning model may include (i) a K-means model, (ii) Density-Based Spatial Clustering of Applications with Noise (DB-SCAN), (iii) Gaussian Mixture Models, (iv) OPTICS (Ordering Points to Identify the Clustering Structure), BIRCH (Balanced Iterative Reducing and Clustering using Hierarchies), etc.

At operation 304, the request may be processed using embeddings for using embeddings for the data sources and the intent embedding of the entity to obtain an information recommendation. The request may be processed by using the intent embedding, a set of historical actions of the entity, and/or the embeddings for the data sources to filter, prioritize, and/or retrieve the information recommendation of the request. The information recommendation may include an identification of relevant data for use in the provisioning of the desired computer implemented services.

At operation 306, the information recommendation may be used to facilitate provisioning of desired computer implemented services. The information recommendation may be used by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, (v) facilitating the performance, addition, modification, removal, monitoring, securing, etc. of any process, data, software, hardware, etc. to any portion of the distributed system.

The method may end following operation 306.

Thus, via the method shown in FIG. 3, embodiments herein may likely improve a likelihood of managing the data sources of the distributed system. By improving the likelihood of managing the data sources of the distributed system, the distributed system may be more likely to provide desirable computer implemented services by, for example, generating the intent embedding based on a category of a behavior for entity actions, using at least the intent embeddings to generate information recommendations, based on the request, from the data sources for the entity, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data sources of a distributed system, the method comprising:
obtaining a request for information from an entity;
identifying an intent embedding of the entity with respect to the request;
processing the request using embeddings for the data sources and the intent embedding of the entity to obtain an information recommendation; and
using the information recommendation to facilitate provisioning of desired computer implemented services.

2. The method of claim 1, wherein the request for the information lacks details about the information.

3. The method of claim 1, wherein the embeddings for the data sources correspond to at least data headers, data statistics, and a set of discrete actions performed by entities in the past, the set of the discrete actions having been performed on the distributed system before the request for the information is obtained.

4. The method of claim 3, wherein the information recommendation comprises an identification of relevant data of the data sources, based on at least the set of the discrete actions performed by the entity, for use in the provisioning of the desired computer implemented services.

5. The method of claim 3, wherein a discrete action of the discrete actions comprises a single task performed by the entity on the distributed system using data of the data sources that does not indicate a class of behavior based on a sequence of single tasks.

6. The method of claim 3, wherein identifying the intent comprises:
obtaining the set of the discrete actions performed by the entity in the past with respect to the data sources; and
obtaining the intent embedding for the set of actions based on an embedding schema used, at least in part, to obtain the embeddings for the data sources.

7. The method of claim 6, wherein the intent embedding corresponds to a behavior of a set of behaviors.

8. The method of claim 7, wherein the behavior of the set of the behaviors comprises at least one selected from a list consisting of:
data exploration;
data preparation;
insight generation;
operational management; and
incident response generation.

9. The method of claim 8, wherein the intent embedding is based on at least one discrete action of the entity and on the behavior of the entity.

10. The method of claim 9, wherein the intent embedding is generated using unsupervised learning using at least the at least one discrete action of the entity.

11. A non-transitory machine-readable medium having instructions stored therein, which when executed by a processor, cause the processor to perform operations for managing data sources of a distributed system, the operations comprising:
obtaining a request for information from an entity;
identifying an intent embedding of the entity with respect to the request;
processing the request using embeddings for the data sources and the intent embedding of the entity to obtain an information recommendation; and
using the information recommendation to facilitate provisioning of desired computer implemented services.

12. The non-transitory machine-readable medium of claim 11, wherein the request for the information lacks details about the information.

13. The non-transitory machine-readable medium of claim 11, wherein the embeddings for the data sources correspond to at least data headers, data statistics, and a set of discrete actions performed by entities in the past, the set of the discrete actions having been performed on the distributed system before the request for the information is obtained.

14. The non-transitory machine-readable medium of claim 13, wherein the information recommendation comprises an identification of relevant data of the data sources, based on at least the set of the discrete actions performed by the entity, for use in the provisioning of the desired computer implemented services.

15. The non-transitory machine-readable medium of claim 13, wherein a discrete action of the discrete actions comprises a single task performed by the entity on the distributed system using data of the data sources that does not indicate a class of behavior based on a sequence of single tasks.

16. A data processing system, comprising:
a processor; and
a memory coupled to the processor to store instructions, which when executed by the processor, cause the processor to perform operations managing data sources of a distributed system, the operations comprising:
obtaining a request for information from an entity;
identifying an intent embedding of the entity with respect to the request;
processing the request using embeddings for the data sources and the intent embedding of the entity to obtain an information recommendation; and
using the information recommendation to facilitate provisioning of desired computer implemented services.

17. The data processing system of claim 16, wherein the request for the information lacks details about the information.

18. The data processing system of claim 16, wherein the embeddings for the data sources correspond to at least data headers, data statistics, and a set of discrete actions performed by entities in the past, the set of the discrete actions having been performed on the distributed system before the request for the information is obtained.

19. The data processing system of claim 18, wherein the information recommendation comprises an identification of relevant data of the data sources, based on at least the set of the discrete actions performed by the entity, for use in the provisioning of the desired computer implemented services.

20. The data processing system of claim 18, wherein a discrete action of the discrete actions comprises a single task performed by the entity on the distributed system using data of the data sources that does not indicate a class of behavior based on a sequence of single tasks.
